(19) United States
(12) Patent Application Publication
(10) Pub. No.: US 2020/0326438 A1
(43) Pub. Date: Oct. 15, 2020

(54) RADIATION POSITION DETECTOR AND PET DEVICE

(71) Applicant: HAMAMATSU PHOTONICS K.K., Hamamatsu-shi, Shizuoka (JP)

(72) Inventors: Ryosuke OTA, Hamamatsu-shi, Shizuoka (JP); Ryoko YAMADA, Hamamatsu-shi, Shizuoka (JP); Takahiro MORIYA, Hamamatsu-shi, Shizuoka (JP)

(73) Assignee: HAMAMATSU PHOTONICS K.K., Hamamatsu-shi, Shizuoka (JP)

(21) Appl. No.: 16/090,655

(22) PCT Filed: Apr. 4, 2017
(86) PCT No.: PCT/JP2017/014102

§ 371 Date: Oct. 2, 2018

(30) Foreign Application Priority Data
Apr. 6, 2016 (JP) 2016-076492
Oct. 28, 2016 (JP) 2016-211834

(51) Int. Cl. G01T 1/29

(52) U.S. Cl. CPC G01T 1/2985

(57) ABSTRACT

A radiation position detector includes a radiator including a medium that generates Cherenkov light by interacting with an incident radiation, a photodetector including a plurality of two-dimensionally arrayed pixels, the plurality of pixels being disposed to correspond to a predetermined surface of the radiator, and a control unit that acquires position information and time information of the plurality of pixels which have detected the Cherenkov light on the basis of a signal output from the photodetector, and obtains a position of a generation place of the Cherenkov light in the radiator on the basis of the acquired position information and the acquired time information, and a propagation locus of the Cherenkov light in the radiator.

### TECHNICAL FIELD

The present disclosure relates to a radiation position detector and a PET device.

### BACKGROUND ART

In the related art, a detector that detects Cherenkov light generated when radiation is incident on a radiator (medium) to detect a position at which the radiation interacts with a medium in the radiator is known. For example, Non-Patent Literature 1 discloses a detector in which all six surfaces of a cube-shaped radiator are covered with a photodetector. In this detector, a position at which the radiation interacts with a medium in the radiator is determined from a distribution of arrival times and arrival places of the Cherenkov light detected by the photodetector.

Further, Non-Patent Literature 2 discloses a TOF-PET device using Cherenkov light. In this device, segments in which radiation interacts with high time resolution are determined by detecting the Cherenkov light generated by a radiator divided into the segments.

Further, Non-Patent Literature 3 discloses a ring image type Cherenkov detector. In this detector, a radiator is disposed on a trajectory of particles carried by an accelerator, and a photodetector is disposed behind the radiator. In this detector, particles are identified from a size of a ring that is detected by the photodetector.

### CITATION LIST

### Non Patent Literature

Non-Patent Literature 1: Somlai-Schweiger and S.I/Ziegler “Concept definition and implementation challenges of a Cherenkov-based detector block for PET,” Medical Physics, vol. 42 (4), pp. 1825-35, 2015
Non-Patent Literature 2: S. Korpar et al., “Study of TOF PET using Cherenkov light,” Nucl. Instrum. Methods Phys. Res. Sect. A, vol. 654, pp. 532-538, 2011
Non-Patent Literature 3: S. Iwata et al., “Development of Ring Imaging Cherenkov Counter for Belle II experiment at super KEKB” Phys. Proc., Vol. 37, pp. 820-829, 2012

### SUMMARY OF INVENTION

### Technical Problem

However, in the technology described in Non-Patent Literature 1, since a total of six surfaces are covered with the photodetector, the amounts of detected signals increase. Also, a unique time resolution included in the photodetector is not considered. Therefore, with this technology, it is difficult to accurately detect the position at which the radiation interacts with the medium in the radiator because of finite time resolution of the photodetector.

Further, in the technology described in Non-Patent Literature 2, the segment at which the interaction has occurred is determined by dividing the radiator into segments. Therefore, information on the interaction position is limited by a size of the segments of the radiator. In this case, there is concern that improvement of spatial resolution is limited.

Further, an object of the technology described in Non-Patent Literature 3 is to identify particles, and it is a prerequisite that the interaction position in the radiator is fixed. Therefore, it is difficult to detect the position of the interaction between the radiation and the radiator on the basis of this technology.

An object of the present disclosure is to provide a radiation position detector and a PET device capable of accurately specifying a position and a time at which radiation interacts with a medium in a radiator.

### Solution to Problem

A radiation position detector and a PET device according to an aspect of the present disclosure include a radiator including a medium that generates Cherenkov light by interacting with incident radiation; a photodetector including a plurality of two-dimensionally arrayed pixels, the plurality of pixels being disposed to correspond to a predetermined surface of the radiator; and a control unit that acquires position information and time information of the plurality of pixels which have detected the Cherenkov light on the basis of a signal output from the photodetector, and obtains a position of a generation place of the Cherenkov light in the radiator on the basis of the acquired position information and the acquired time information, and a propagation locus of the Cherenkov light in the radiator.

In such a radiation position detector and a PET device, when radiation is incident on the radiator, the radiation interacts with the medium and photoelectrons are emitted. When photoelectrons emit the Cherenkov light in the radiator, the Cherenkov light is detected by the plurality of pixels constituting the photodetector. The Cherenkov light with high directivity propagates in one direction within a non-segmented radiator. Therefore, it is possible to obtain the position of the generation place of the Cherenkov light by tracing the propagation locus of the Cherenkov light from the position information and the time information of the plurality of pixels which have detected the Cherenkov light. This position of the generation place can be considered to be substantially the same as the generation place of the photoelectrons, that is, the interaction position of the radiation. Therefore, it is possible to accurately specify a position and a time at which the radiation has interacted with the medium in the radiator from the obtained position of the generation place of Cherenkov light.

Further, the control unit may obtain the position of the generation place using the propagation locus of the Cherenkov light when photoelectrons are emitted from a K shell of an atom which most easily causes a photoelectric effect among atoms constituting the medium. An emission angle of the Cherenkov light is determined on the basis of a refractive index of the medium and binding energy of the K shell of the atom that has emitted the photoelectrons. Therefore, it becomes unnecessary to consider a plurality of emission angles of the Cherenkov light by assuming that the photoelectrons are emitted from the K shell of the atom which most easily causes the photoelectric effect.

Further, the propagation locus of the Cherenkov light may have a conical shape centered on a locus of photoelectrons emitted by the radiation interacting with the medium, and the position of the generation place may be a position of an apex of the conical shape. It is possible to uniquely determine the position at which the radiation interacts with the medium in the radiator by obtaining the position of the generation place of the Cherenkov light as the position of the apex of the conical shape.

Further, the control unit may obtain the position of the apex of the conical shape on the basis of ellipse information on an ellipse to be fitted to the plurality of pixels which have detected the Cherenkov light. The Cherenkov light spreads in a conical shape centered on a traveling locus of photoelectrons. Thus, when photoelectrons travel at an angle with respect to the photodetector, the positions indicated by the plurality of pieces of detected position information are disposed on a trajectory of the ellipse. Therefore, it is possible to obtain the position of the apex of the conical shape more accurately by using information on an ellipse to which a plurality of actually detected pixels are fitted.

Further, the propagation locus of the Cherenkov light may have a conical shape centered on a locus of photoelectrons emitted by the radiation interacting with the medium, and the control unit may obtain a position of a centroid of the plurality of pixels which have detected the Cherenkov light, obtain a position of an apex of the conical shape on the basis of ellipse information on an ellipse centered on the centroid, the ellipse being fitted to the plurality of pixels which have detected the Cherenkov light, set a position of the centroid in a direction parallel to the predetermined surface as a position of the generation place in the direction parallel to the predetermined surface, and set a position of the apex in a direction perpendicular to the predetermined surface as the position of the generation place in the direction perpendicular to the predetermined surface. Accordingly, it is possible to accurately specify the position and the time at which the radiation interacts with the medium in the radiator even when the photoelectrons emitted by the interaction of the radiation with the medium do not go straight.

Further, the control unit may obtain the position of the generation place when the number of the plurality of pixels which have detected the Cherenkov light in a predetermined period of time is larger than a predetermined number on the basis of the time information and may not obtain the position of the generation place when the number of the plurality of pixels which have detected the Cherenkov light in the predetermined period of time is smaller than the predetermined number on the basis of the time information. The Cherenkov light detected in a predetermined period of time can be considered to be emitted due to the same radiation. When the propagation locus of the Cherenkov light is traced from the position information of the photodetector, it is difficult to accurately specify the interaction position when the number of pixels which have detected the Cherenkov light is small. Therefore, it is possible to improve the accuracy of position specifying by obtaining the position of the generation place of Cherenkov light when the number of pixels which have detected the Cherenkov light is larger than the predetermined number and not obtaining the position of the generation place of Cherenkov light when the number of pixels which have detected the Cherenkov light is smaller than the predetermined number.

Further, the radiation position detector and the PET device may further include a light absorption layer provided on an outer surface of the radiator other than the predetermined surface and configured to absorb the Cherenkov light. Accordingly, it is possible to suppress reflection of the Cherenkov light on the medium surface, and reduce noise.

### Advantageous Effects of Invention

With the radiation position detector and the PET device according to an aspect of the present disclosure, it is possible to accurately specify the position and the time at which the radiation interacts with the medium in the radiator.

### BRIEF DESCRIPTION OF DRAWINGS

FIG. 1(a) is a schematic view of a PET device according to a first embodiment, and FIG. 1(b) is a sectional view of a detector ring in the PET device.

FIG. 2 is a configuration diagram of a radiation position detector according to the first embodiment.

FIGS. 3(a) and 3(b) are schematic diagrams illustrating an aspect of Cherenkov light that is emitted in a medium.

FIGS. 4(a) and 4(b) are diagrams illustrating a principle of specifying an interaction position of radiation in a medium.

FIGS. 5(a) and 5(b) are diagrams illustrating the principle of specifying interaction positions of radiation in a medium.

FIG. 6 is a flowchart showing an aspect of a processing flow for specifying an interaction position in a control unit of the first embodiment.

FIG. 7 is a configuration diagram of a radiation position detector according to a second embodiment.

FIG. 8 is a flowchart showing an aspect of a processing flow for specifying an interaction position in a control unit of the second embodiment.

FIGS. 9(a), 9(b), 9(c) and 9(d) are diagrams illustrating a principle of specifying an interaction positions of a radiation in a medium.

FIGS. 10(a) and 10(b) are schematic diagrams illustrating another aspect of Cherenkov light that is emitted in a medium.

FIG. 11 is a flowchart showing another aspect of a process flow for specifying the interaction position in the control unit of the first embodiment.

### DESCRIPTION OF EMBODIMENTS

Hereinafter, embodiments of the present disclosure will be specifically described with reference to the drawings. For convenience, elements that are substantially the same are denoted by the same reference numerals, and description thereof may be omitted.

### First Embodiment

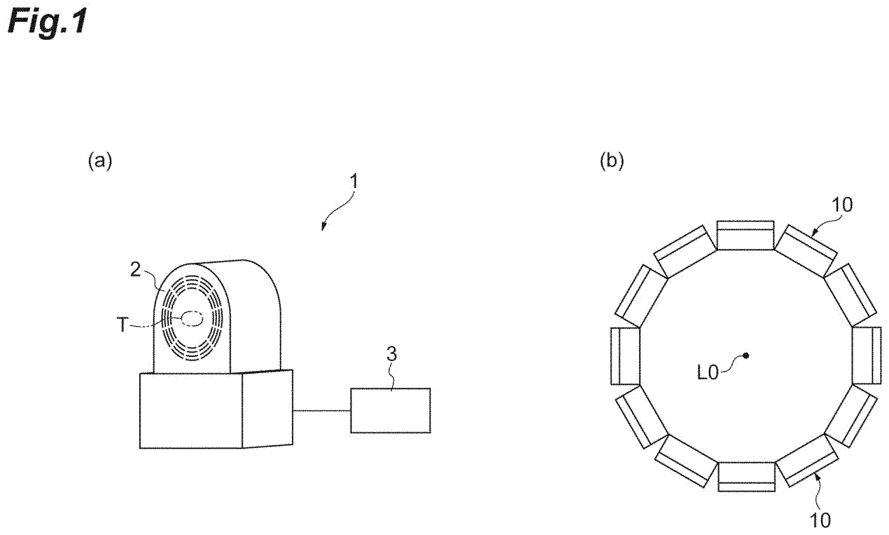

FIG. 1(a) is a schematic diagram of a positron emission tomography (PET) device of a first embodiment. FIG. 1(b) is a sectional view of a detector ring of the PET device. As illustrated in FIGS. 1(a) and 1(b), the PET device 1 includes a bed (not illustrated) on which a subject T is placed, a gantry 2 having an opening with a circular cross section, and an image processing unit 3 to which data detected by a detector ring within the gantry 2 is transferred. Further, in the detector ring within the gantry 2 of the PET device 1, a plurality of radiation position detectors 10 are disposed in a ring shape in contact with each other on a circumference having a predetermined line L0 as a center line. The PET device 1 is a device that detects γ rays (radiation) that are emitted from the subject T to which a drug labeled with a positron emitting nuclide (a radioactive isotope emitting positrons) is administered, in order to acquire a tomographic image of the subject T at a plurality of slice positions.

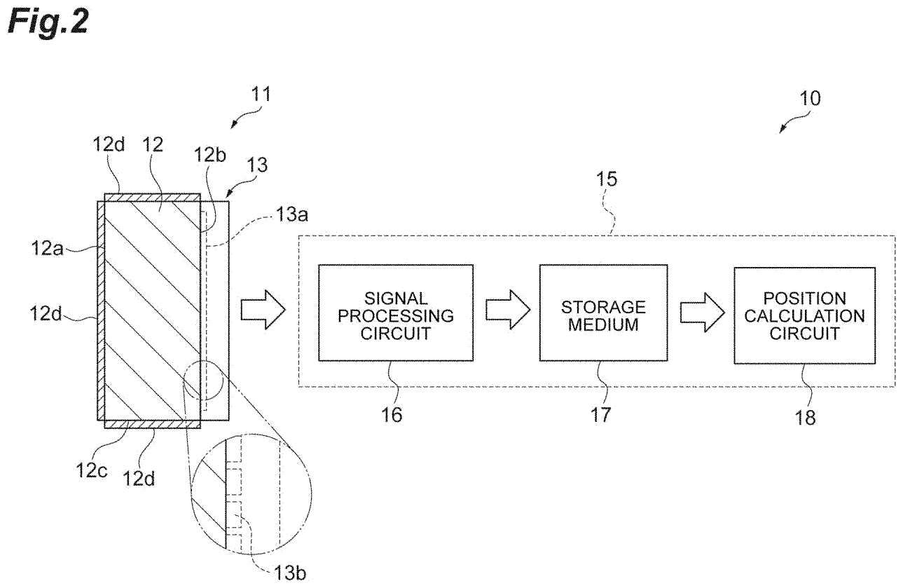

FIG. 2 is a block diagram illustrating a configuration of the radiation position detector. As illustrated in FIG. 2, the radiation position detector 10 includes a detector 11 having a radiator 12 and a photodetector 13, and a control unit 15 includes a signal processing circuit 16, a storage medium 17, and a position calculation circuit 18. The radiation position detector 10 of the first embodiment three-dimensionally determines a position at which the γ rays emitted from the subject T interact with a medium in the radiator 12.

The radiator 12 is made of a medium that generates Cherenkov light by interacting with the incident γ rays. The radiator 12 has, for example, a flat plate shape including a surface 12a on which γ rays are incident, a back surface (predetermined surface) 12b facing the front surface 12a, and a side surface 12c connecting the front surface 12a to the back surface 12b. In the PET device 1 of the first embodiment, the radiator 12 in each of the plurality of radiation position detectors 10 is disposed so that the front surface 12a thereof faces the predetermined line L0. In the radiator 12, the photoelectric effect occurs due to the interaction of the incident radiation. For example, when the radiator 12 contains atoms having great atomic numbers, it is easy for the photoelectric effect to occur. Further, generation of scintillation light in the radiator 12 may cause noise. Therefore, the radiator 12 can be formed of a medium containing atoms having great atomic numbers and that does not easily generate the scintillation light (for example, lead glass (SiO₂+PbO), lead fluoride (PbF₂), or PWO (PbWO₄)).

A light absorption layer 12d that absorbs light generated in the radiator 12 is provided on the front surface 12a and the side surface 12c, which are outer surfaces of the radiator 12 other than the back surface 12b. The light absorption layer 12d is, for example, a black tape adhered to the front surface 12a and the side surface 12c. Further, the light absorption layer 12d may be a black coating film applied to the front surface 12a and the side surface 12c.

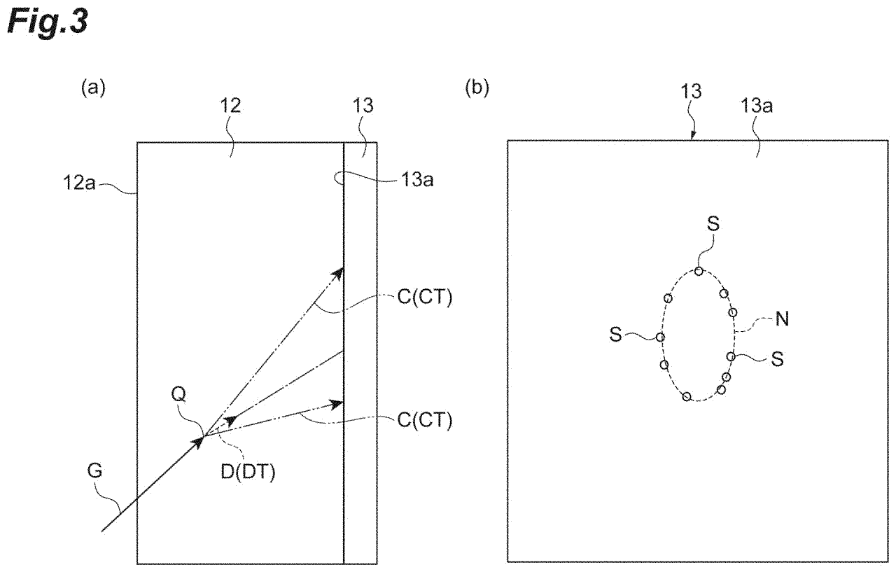

FIG. 3 is a schematic diagram illustrating an aspect of Cherenkov light that is emitted in the radiator 12. FIG. 3(a) schematically illustrates the radiator 12 and the photodetector 13 in a cross section, and FIG. 3(b) schematically illustrates the photodetector 13 in a plan view. As illustrated in FIG. 3(a), when γ rays G are incident on the surface 12a of the radiator 12, the γ rays G interact in the radiator 12 and photoelectrons D are emitted. The Cherenkov light C is emitted in the radiator 12 by the photoelectrons D. The Cherenkov light C draws a propagation locus CT spreading in a conical shape about a locus DT of the photoelectrons D. When the locus DT of the photoelectrons D is at an angle with respect to a detection surface 13a, an ellipse N is formed when positions S of the pixels 13b detecting the Cherenkov light C are connected, as illustrated in FIG. 3(b).

Referring back to FIG. 2. The photodetector 13 is provided on the back surface 12b of the radiator 12 to detect the Cherenkov light generated in the radiator 12. The photodetector 13 includes the detection surface 13a on which a plurality of pixels 13b performing photoelectric conversion are arranged two-dimensionally. The plurality of pixels 13b correspond to the back surface 12b of the radiator 12. More specifically, the photodetector 13 is coupled to the radiator 12 so that the back surface 12b and the detection surface 13a face each other. Each pixel 13b can hold a segment address which is position information of the pixel 13b on the detection surface 13a and a detection time at which the Cherenkov light is detected. The photodetector 13 outputs the segment address and the time information indicating the detection time to the control unit 15 as list data. Each pixel 13b may include, for example, a single photon avalanche diode (SPAR).

The control unit 15 includes a signal processing circuit 16, a storage medium 17, and a position calculation circuit 18. The signal processing circuit 16 acquires a plurality of pieces of list data from the photodetector 13 and sorts the acquired list data on the basis of the time information. Further, the signal processing circuit 16 determines whether or not the acquired list data is valid. When it is determined that the list data is valid, the signal processing circuit 16 stores the list data in the storage medium 17. The validity of the list data is determined on the basis of whether or not the number of pieces of list data of the pixels 13b which have detected the Cherenkov light emitted due to the same γ rays is equal to or greater than a predetermined number. For example, it is possible to determine the validity of the list data according to whether or not the number of pieces of list data falling within a time window having a predetermined time width is equal to or greater than a predetermined number. In this case, the time width of the time window is set so that only the pixels 13b which have detected the Cherenkov light at the same time fall within the time window and is, for example, 500 ps.

The position calculation circuit 18 acquires the plurality of pieces of list data determined to be valid by the signal processing circuit 16 from the storage medium 17. The position of the generation place of the Cherenkov light is calculated from the plurality of pieces of list data on the basis of the propagation locus of the Cherenkov light in the radiator 12. The position calculation circuit 18 is, for example, a computer including a CPU in which a calculation process is performed, a storage device including a memory such as a RAM and a ROM, and an input and output device. Further, the position calculation circuit 18 may include a field-programmable gate array (FPGA) circuit.

Here, a principle of determining the position at which the γ rays G interact with the medium in the radiator 12 will be described. In the position calculation circuit 18, calculation of the interaction position is executed on the basis of this determination principle. As illustrated in FIG. 3, the Cherenkov light C depicts a propagation locus CT spreading in a conical shape about a traveling locus DT of the photoelectrons D. When a refractive index of the radiator 12 is n and a velocity of photoelectrons in the radiator 12 is β, an emission angle θc of such

Cherenkov light C satisfies a relationship of Equation (1).

$$\begin{matrix}[ Math . 1 ] & \\ cos {θ}_{c} = \frac{1}{n β} & ( 1 )\end{matrix}$$

In the first embodiment, the interaction position is calculated using the propagation locus CT of the Cherenkov light C when the photoelectrons D are emitted from the K shell of the atoms which most easily cause the photoelectric effect among the atoms constituting the radiator 12. When energy of the incident γ rays G is E_{γ}, the mass of the electrons is m_{c}, and the binding energy of the K shell of the atoms causing the photoelectric effect is E_{B.E.}, the emission angle θ_{c} of the Cherenkov light C is a constant angle as shown by Equation (2).

$$\begin{matrix}[ Math . 2 ] & \\ {θ}_{c} = acos ( \frac{{E}_{γ} + {m}_{e} - {E}_{B . E .}}{\sqrt[n]{{( {E}_{γ} + {m}_{e} - {E}_{B . E .} )}^{2} - {m}_{e}^{2}}} ) & ( 2 )\end{matrix}$$

Therefore, it is possible to specify the shape of the cone forming the propagation locus CT of the Cherenkov light C on the basis of the segment address indicating the position of the pixels 13b which have detected the Cherenkov light C. A position of an apex of the cone is a position Q of the generation place of the Cherenkov light C and is substantially the same as the generation place of the photoelectrons D, that is, the interaction position of the γ rays G.

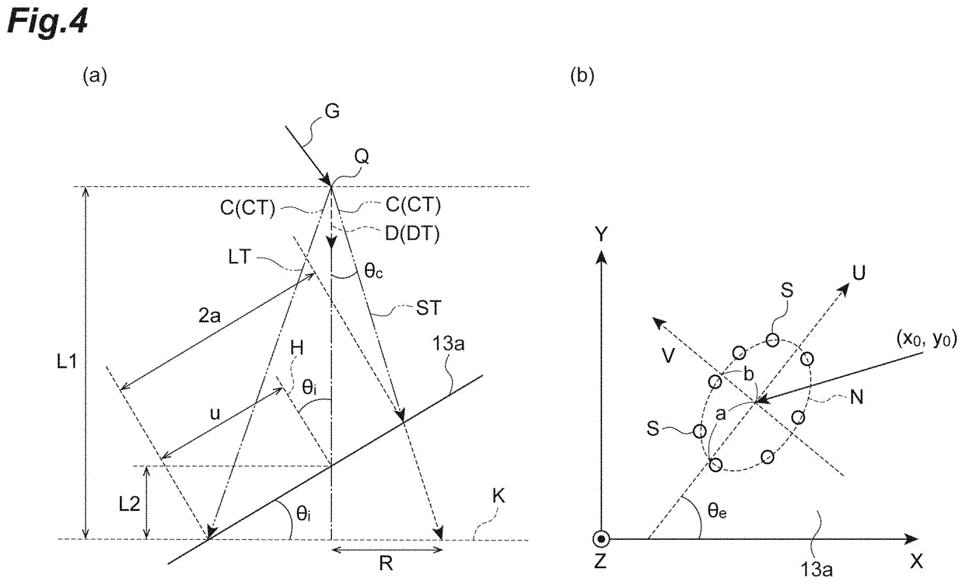

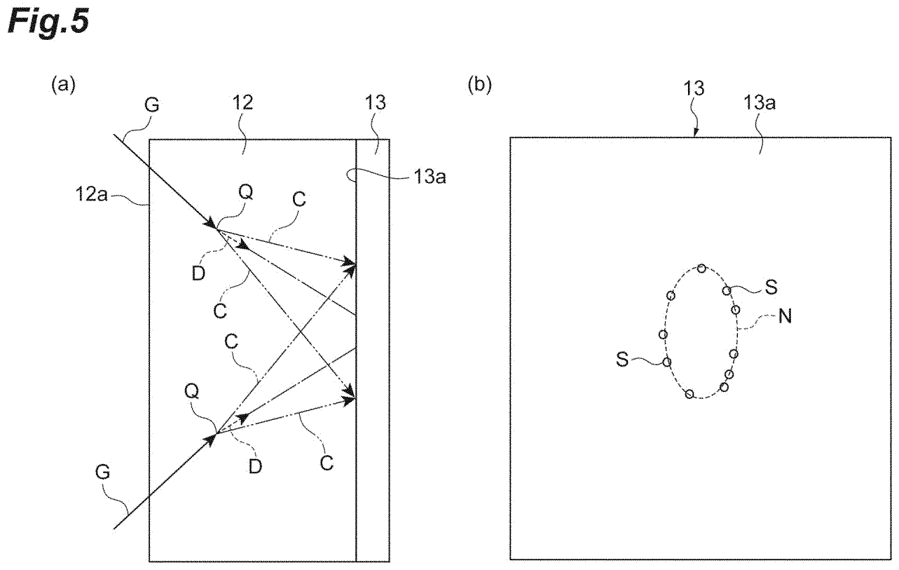

FIGS. 4 and 5 are diagrams illustrating a principle of specifying the interaction position of the γ rays in the radiator. In the following description, an origin is set at an arbitrary position on the detection surface 13a of the photodetector 13. The interaction position is specified by an orthogonal coordinate system including an X axis and a Y axis set on the detection surface 13a and a Z axis extending to the radiator 12. In this case, a normal H of the detection surface 13a of the photodetector 13 is along the Z axis. When the photoelectron D is incident at a predetermined angle with respect to the normal H of the detection surface 13a, the Cherenkov light C detected by the photodetector 13 draws an ellipse N. FIG. 4(a) illustrates a plane along an axis line U and a normal H of a major axis of the ellipse N detected by the photodetector 13. FIG. 4(b) illustrates an X-Y plane.

In FIG. 4(a), the detection surface 13a along the major axis of the ellipse N is indicated by a solid line, and a traveling locus DT of the photoelectrons D is indicated by a broken line. Further, the propagation locus CT of the Cherenkov light C is indicated by a two-dot chain line. Further, an angle formed by the normal H of the detection surface 13a and the traveling locus DT of the photoelectrons D is θᵢ, and an emission angle of the Cherenkov light C is θ_{c}. In FIG. 4(a), a locus having a shortest distance from the position Q of the generation place to the detection surface 13a (hereinafter sometimes referred to as “short side ST”) and a locus having a longest distance from the position Q of the generation place to the detection surface 13a (hereinafter sometimes referred to as a “long side LT”) among the propagation trajectories CT of the Cherenkov light C are shown. It should be noted that an intersection of the short side ST and the long side LT corresponds to the position Q of the generation place, and the γ rays G incident on the radiator 12 interact at the position.

In FIG. 4(b), an ellipse N fitted to the positions of the pixels 13b which have detected Cherenkov light C is drawn. This ellipse N is a shape obtained by cutting the propagation locus CT of the Cerenkov light C forming a conical shape at an angle θᵢ, and has a major axis with a length a and a minor axis with a length b. Further, in FIG. 4(b), an axis U along the major axis of the ellipse N and an axis V along the minor axis are shown. In this case, an angle formed by the axis line U and the X axis is an angle θₑ. Further, coordinates of a center point of the ellipse N are indicated by (X₀, Y₀).

In FIG. 4, an imaginary line perpendicular to the traveling locus DT of the photoelectrons D and passing through an intersection between the long side LT and the detection surface 13a is defined as a line K. Here, a distance from the line K to the position Q of the generation place is set to L1. Further, a distance from an intersection between an extended line of the traveling locus DT of the photoelectrons D and the line K to an intersection of the extended line of the short side ST or an intersection between the long side LT and the line K is set to R. Further, a distance from an intersection between an extended line of the traveling locus DT of the photoelectrons D and the detection surface 13a to the line K is set to L2. Further, a distance from an intersection between the extended line of the traveling locus DT of the photoelectrons D and the detection surface 13a to the intersection between the long side LT and the line K is set to u. In this case, tan θc, L2, and u can be represented by Equations (3), (4) and (5) below, respectively.

$$\begin{matrix}[ Math . 3 ] & \\ tan {θ}_{c} = \frac{R}{L 1} & ( 3 ) \\ [ Math . 4 ] & \\ L 2 = R tan {θ}_{i} & ( 4 ) \\ [ Math . 5 ] & \\ u = a \frac{tan {θ}_{i} + tan ( \frac{π}{2} - {θ}_{c} )}{tan ( \frac{π}{2} - {θ}_{c} )} & ( 5 )\end{matrix}$$

Here, when P is defined as shown in Equation (6) below, a length a of the major axis and a length b of the minor axis are represented by Equations (7) and (8), respectively.

$$\begin{matrix}[ Math . 6 ] & \\ P = \frac{tan {θ}_{c} tan {θ}_{i}}{1 + tan {θ}_{c} tan {θ}_{i}} & ( 6 ) \\ [ Math . 7 ] & \\ a = \frac{R ( 1 - P )}{cos {θ}_{i}} & ( 7 ) \\ [ Math . 8 ] & \\ b = R \times \sqrt{1 - 2 P} & ( 8 )\end{matrix}$$

A position of the apex of the conical shape obtained from the above equations, that is, coordinates (x, y, z) of the position Q of the generation place of the Cherenkov light C, are determined according to two Equations (9) and (10).

$$\begin{matrix}[ Math . 9 ] & \\ x = ( ( u - a ) - ( L 1 - L 2 ) sin {θ}_{i} ) cos {θ}_{e} + {x}_{0} & ( 9 ) \\ y = ( ( u - a ) - ( L 1 - L 2 ) sin {θ}_{i} ) sin {θ}_{e} + {y}_{0} & \\ z = ( L 1 - L 2 ) cos {θ}_{i} & \\ [ Math . 10 ] & \\ x = - ( ( u - a ) - ( L 1 - L 2 ) sin {θ}_{i} ) cos {θ}_{e} + {x}_{0} & ( 10 ) \\ y = - ( ( u - a ) - ( L 1 - L 2 ) sin {θ}_{i} ) sin {θ}_{e} + {y}_{0} & \\ z = ( L 1 - L 2 ) cos {θ}_{i} & \end{matrix}$$

FIG. 5(a) schematically illustrates the radiator 12 and the photodetector 13 in a cross-sectional view, and FIG. 5(b) schematically illustrates the photodetector 13 in a plan view. As illustrated in FIG. 5(a), the position Q of the generation place determined by Equations (9) and (10) appears at two places including one side and the other side in the major axis direction of the ellipse N. Therefore, it is difficult to determine, from only a shape of the ellipse N as illustrated in FIG. 5(b), which of candidates for the position Q of the two generation places including the one side and the other side in the major axis direction of the ellipse N is a position Q of an actual generation place. Therefore, one of the two candidates (v vector=(x, y, z)) shown in Equations (9) and (10) is specified as the position Q of the actual generation place using Equation (11) below.

$$\begin{matrix}[ Math . 11 ] & \\ {τ}_{i} = {t}_{i} - \frac{n}{c} \vert \vec{{r}_{i}} - \vec{v} \vert & ( 11 )\end{matrix}$$

Here, “i” means an i-th photon. That is, tᵢ is a parameter indicating a detection time of the pixel 13b which has detected the i-th photon, and an rᵢ vector is a vector from an origin to the pixel 13b which has detected the i-th photon. Further, c is the speed of light in a vacuum. In the first embodiment, a τᵢ distribution is obtained for each event, variance values thereof are compared, and the candidate with the smaller variance is adopted as the position Q of the generation place, that is, as an interaction point.

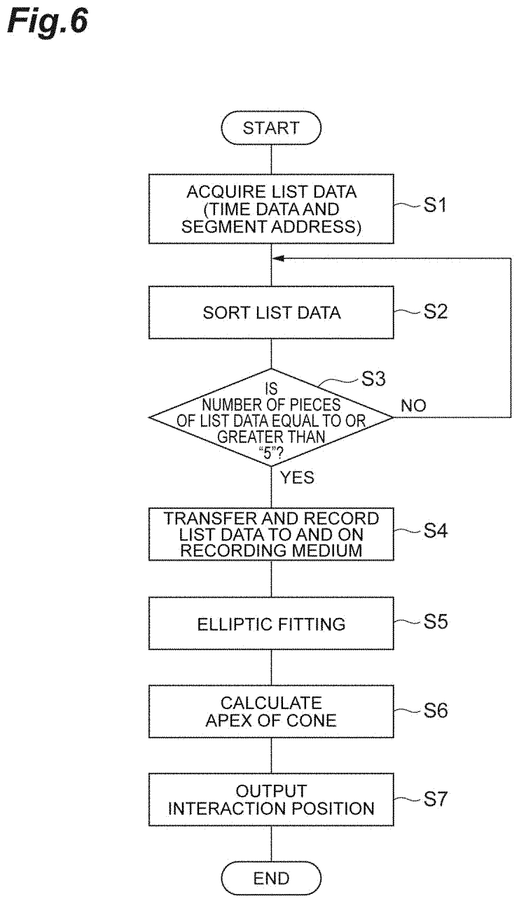

Next, a processing flow by the control unit 15 will be described. FIG. 6 is a flowchart showing one embodiment of a processing flow for specifying the interaction position in the control unit 15. First, the signal processing circuit 16 acquires list data output from each pixel 13b of the photodetector 13 (step S1). The list data includes time information indicating a time when the pixel 13b detects Cherenkov light and a segment address indicating the position of the pixel 13b.

The signal processing circuit 16 sorts the plurality of pieces of acquired list data on the basis of the time information (step S2). The signal processing circuit 16 acquires a list data group that falls within the time window from the sorted list data, and determines the number of pieces of list data constituting the acquired list data group (step S3). In this case, a difference between the pieces of time information of the respective pieces of list data constituting the list data group is within the time width of the time window. In step S3, when the number of pieces of list data constituting the list data group is equal to or greater than the predetermined number, the list data is transferred to and stored in the storage medium 17 (step S4). Further, when the number of pieces of list data constituting the list data group is smaller than the predetermined number, this list data is processed as invalid data. In this case, the position Q of a generation place of the Cherenkov light C is not obtained. As an example, in step S3, it is determined that the list data is valid data when the number of pieces of list data is equal to or greater than five. Here, a threshold value can be arbitrarily determined in practice.

Subsequently, the position calculation circuit 18 performs elliptic fitting on the basis of the list data group stored in the storage medium 17 (step S5). That is, the position calculation circuit 18 derives an ellipse to which the position indicated by the segment address of each piece of list data constituting the list data group is fitted. In the first embodiment, since the number of pieces of list data constituting the list data group is equal to or greater than five, one ellipse can be specified. The elliptical fitting can be obtained by approximation using, for example, robust estimation. The position calculation circuit 18 acquires coordinates of a center (X₀, Y₀) of the ellipse, a length a of the major axis, a length b of the minor axis, and the angle θₑ of the major axis with respect to the X-axis, from the information of the derived ellipse.

The position calculation circuit 18 calculates coordinates of an apex of a cone on the basis of the determination principle using the acquired information of the ellipse (step S6), and outputs a position of the coordinates as the interaction position (step S7). The control unit 15 outputs interaction points in all of the list data group in which the number of pieces of list data is equal to or greater than five. When the coordinate information of the interaction point and the detected time information are transferred to the image processing unit 3, a tomographic image is generated in the image processing unit 3.

In the radiation position detector 10 and the PET device 1 described above, when the γ rays G are incident on the radiator 12, the γ rays G interact with the medium in the radiator 12 and the photoelectrons D are emitted. When the photoelectrons D have emitted the Cherenkov light C in the radiator 12, the Cherenkov light C is detected by the plurality of pixels 13b constituting the photodetector 13. The Cherenkov light C has high directivity and propagates in one direction within the unsegmented radiator 12. Therefore, it is possible to obtain the position Q of the generation place of the Cherenkov light C by tracing the propagation locus CT of the Cherenkov light C from the segment addresses of the plurality of pixels 13b which have detected the Cherenkov light C. This position Q of the generation place is substantially the same as the generation place of the photoelectrons D, that is, the interaction position of the γ rays G. Therefore, it is possible to accurately specify a position (a three-dimensional position) and a time at which the γ rays G have interacted with the medium in the radiator 12 from the obtained position Q of the generation place of Cherenkov light C.

Further, the control unit 15 uses the propagation locus CT of the Cherenkov light C when the photoelectrons D are emitted from the K shell of the atoms which most easily cause the photoelectric effect among the types of atoms constituting the radiator 12. The emission angle θc of the Cherenkov light C is determined by the refractive index n of the radiator 12, the binding energy of the K shell of the atom emitting the photoelectrons D, and the mass of the electrons. That is, even in the same radiator 12, the emission angle θc of the Cherenkov light C varies depending on the atoms emitting the photoelectrons D. In other words, when the types of atoms emitting the photoelectrons D are different, the Cherenkov light C draws different propagation loci. In the first embodiment, it is unnecessary to consider a plurality of emission angles θc of the Cherenkov light C because all the photoelectrons D are assumed to be emitted from the K shell of the atoms that most easily cause photoelectric effect.

Further, the propagation locus CT of the Cherenkov light C is a conical shape centered on the locus of the photoelectrons D emitted by the interaction of the γ rays G with the medium (a conical shape centered on a locus while the photoelectrons emitted by the γ rays G interacting with the medium A goes straight), and the position Q of the generation place is specified as the apex of the conical shape. The interaction position can be uniquely determined by obtaining the position Q of the generation place of the Cherenkov light C as the position of the apex of the conical shape.

Further, the control unit 15 obtains the position of the apex of the conical shape on the basis of the information on the ellipse to be fitted to the plurality of pixels 13b which have detected the Cherenkov light C. The Cherenkov light C spreads in a conical shape centered on the traveling locus DT of the photoelectrons D. Accordingly, when the photoelectrons D travel at an angle with respect to the photodetector 13, positions indicated by the plurality of detected segment addresses are disposed on a trajectory of the ellipse. Therefore, it is possible to obtain the position of the apex of the conical shape more accurately by using the information on the ellipse to which the actually detected positions of the segment address are fitted.

Further, the control unit 15 obtains the position Q of the generation place of the Cherenkov light C when the number of a plurality of pixels 13b (that is, the number of pieces of position information) which have detected the Cherenkov light C in a predetermined period of time (500 p in the above example) that is substantially the same time is equal to or larger than the predetermined number on the basis of the acquired time information, and does not obtain the position Q of the generation place of the Cherenkov light C when the number of the plurality of pixels 13b which have detected the Cherenkov light C in the predetermined period of time is smaller than the predetermined number. The Cherenkov light C detected in a predetermined period of time that is substantially the same time can be considered to be emitted due to the same γ rays G. When the propagation locus CT of the Cherenkov light C is traced from the position information of the plurality of pixels 13b, it is difficult to accurately specify the interaction position when the number of pieces of position information is small. Therefore, it is possible to improve the accuracy of position specifying by obtaining the position Q of the generation place of the Cherenkov light C when the number of pieces of detected position information is equal to or greater than the predetermined number, and by regarding the position information as invalid data (that is, by not obtaining the position Q of the generation place of the Cherenkov light C) when the number of pieces of detected position information is smaller than the predetermined number.

It should be noted that the control unit 15 may obtain the position Q of the generation place when the number of a plurality of pixels 13b which have detected the Cherenkov light C in a predetermined period of time exceeds a predetermined number on the basis of the acquired time information, and may not obtain the position Q of the generation place when the number of the plurality of pixels 13b which have detected the Cherenkov light C in the predetermined period of time is equal to or smaller than the predetermined number on the basis of the acquired time information. That is, the control unit 15 may obtain the position Q of the generation place when the number of a plurality of pixels 13b which have detected the Cherenkov light C in the predetermined period of time is larger than the predetermined number on the basis of the acquired time information, and may not obtain the position Q of the generation place when the number of the plurality of pixels 13b which have detected the Cherenkov light C in the predetermined period of time is smaller than the predetermined number on the basis of the acquired time information.

Further, since the light absorption layer 12d is provided on the surface 12a and the side surface 12c other than the back surface 12b of the radiator 12, it is possible to suppress reflection of the Cherenkov light C on the surface of the medium and reduce noise.

### Second Embodiment

The radiation position detector 110 of the second embodiment is different from the radiation position detector 110 of the first embodiment in that the pixels 113b constituting the photodetector 113 are configured of a silicon photomultiplier (SiPM). Hereinafter, differences from the first embodiment will be mainly described, and the same elements or members are denoted by the same reference numerals, and detailed description thereof will be omitted.

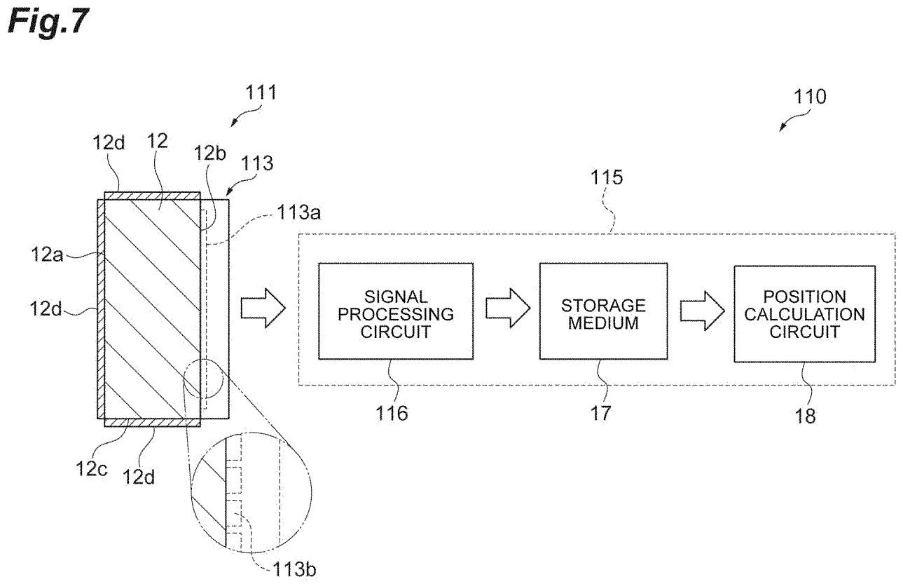

FIG. 7 is a configuration diagram of the radiation position detector of the second embodiment. As illustrated in FIG. 7, the radiation position detector 110 includes a detection unit 111 includes a radiator 12 and a photodetector 113, and a control unit 115 includes a signal processing circuit 116, a storage medium 17, and a position calculation circuit 18. The photodetector 113 is provided on the back surface 12b of the radiator 12 as in the first embodiment and detects the Cherenkov light emitted in the radiator 12. The photodetector 113 includes a detection surface 113a in which a plurality of pixels 113b that perform photoelectric conversion are arranged in an array. Each of the pixels 113b constituting the detection surface 113a outputs an analog signal according to the detected light to the control unit 115. Each pixel 113b may be configured of, for example, an SiPM.

The control unit 115 includes a signal processing circuit 116, a storage medium 17, and a position calculation circuit 18. The signal processing circuit 116 digitizes the analog signal output from the photodetector 113 to acquire the segment address of the pixel 113b which has detected the Cherenkov light. Further, the signal processing circuit 116 acquires a time when the analog signal has been acquired, as time information. The signal processing circuit 116 determines whether or not list data including the acquired segment address and the acquired time information is valid. When it is determined that the list data is valid, the list data is stored in the storage medium 17. A method of determining the validity of the list data is the same as in the first embodiment.

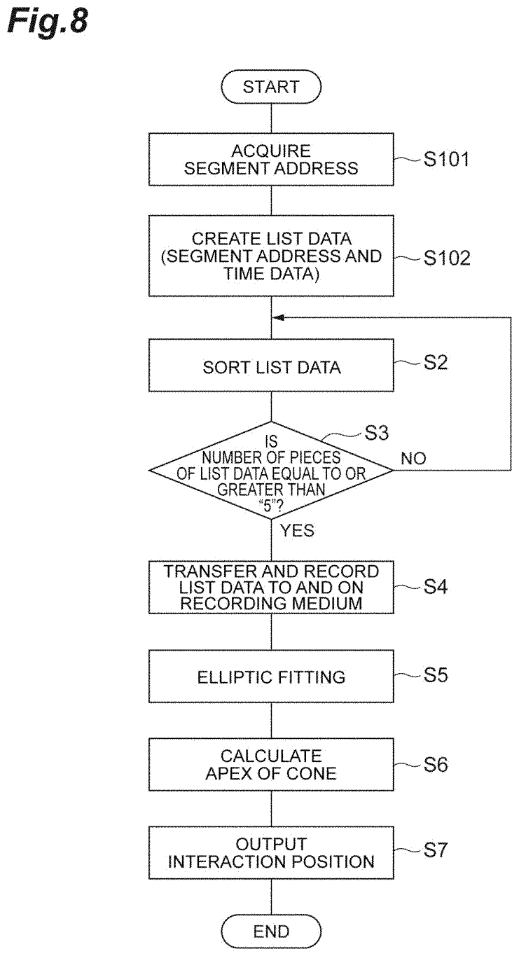

Next, the processing flow in the control unit 115 will be described. FIG. 8 is a flowchart showing an aspect of a processing flow for specifying an interaction position in the control unit 115 of the second embodiment. First, the signal processing circuit 116 acquires a segment address from an analog signal output from each pixel 113b of the photodetection array (step S101). Then, the signal processing circuit 116 creates list data including time information and the segment address (step S102).

Subsequently, the control unit 115 outputs the interaction position through processes of step S2 to step S7, as in the first embodiment (step S7). The control unit 115 outputs interaction points in all of the list data group in which the number of pieces of list data is equal to or greater than five. Coordinate information of the interaction points calculated by the control unit 115 and the detected time information are transferred to the image processing unit 3.

In the radiation position detector 110 of the second embodiment described above, it is possible to accurately specify the position and the time at which the γ ray G interacts with the medium in the radiator 12, as in the first embodiment.

Although the first and second embodiments of the present invention have been described above in detail with reference to the drawings, specific configurations are not limited to the first and second embodiments described above. For example, an example of using Equation (11) has been shown as a method of determining which of the candidates of the position Q of two generation places on one side and the other side in the major axis direction of the ellipse is the position Q of the generation place, but the present invention is not limited thereto.

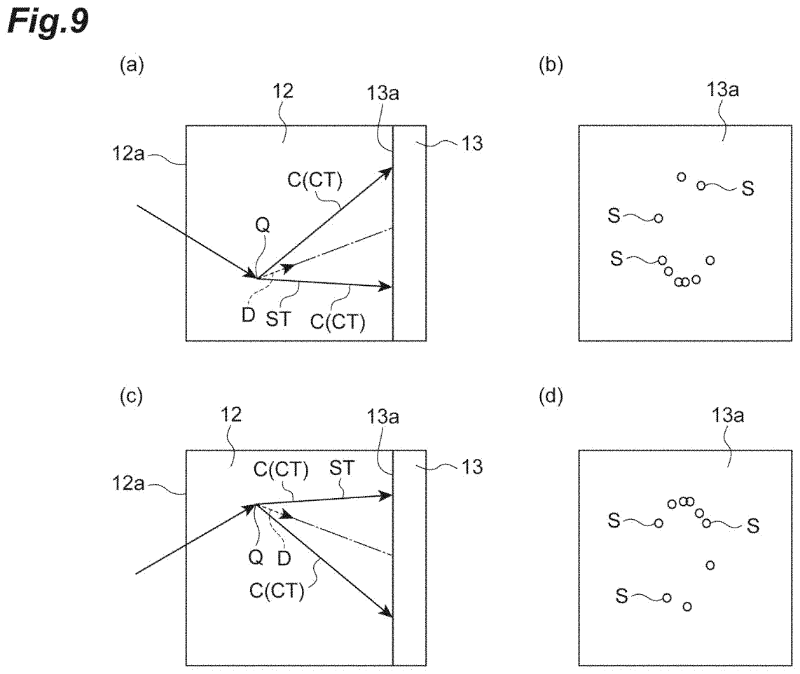

FIG. 9 is a diagram illustrating a principle of another method of determining the position Q of the generation place from the two candidates shown by Equations (9) and (10). FIG. 9(a) is a schematic diagram illustrating a state in which the Cherenkov light C is emitted from one side in the major axis direction of the ellipse (a lower side in FIG. 9). FIG. 9(b) is a schematic diagram illustrating the position S of the pixel which has detected the Cherenkov light C in the case of FIG. 9(a). Further, FIG. 9(c) is a schematic diagram illustrating a state in which the Cherenkov light C is emitted from the other side (the upper side in FIG. 9) in the major axis direction of the ellipse. FIG. 9(d) is a schematic diagram illustrating a position on the detection surface 13a of the pixel which has detected the Cherenkov light in the case of FIG. 9(c).

Since the photons propagating in the radiator 12 can be scattered or absorbed with a certain probability, the shorter the optical path from the position Q of the generation place of the Cherenkov light C to the detection surface 13a, the higher the probability of detection by the pixel, whereas the longer the optical path from the position Q of the generation place of the Cherenkov light C to the detection surface 13a, the lower the probability of detection by the pixel. Therefore, as illustrated in FIGS. 9(b) and 9(d), more photons can be detected by the pixels disposed on the short side ST side, an optical path length of which is short in the propagation locus CT of the Cherenkov light C. Therefore, the position Q of the generation place can be determined from the two candidates by determining whether more photons are detected on the side closer to any one of one side or the other side of the major axis of the ellipse. That is, in FIG. 9(b), since the pixels which have detected the Cherenkov light C (shown as the position S of the pixel in FIG. 9(b)) are biased on the lower side of the ellipse, the photoelectron D is assumed to be emitted from the bottom to the top as illustrated in FIG. 9(a), and it is possible to determine the position Q of the generation place of the Cherenkov light C. Further, in (d) of FIG. 9, since pixels which have detected the Cherenkov light C are biased on the upper side of the ellipse, the photoelectron D is assumed to be emitted from the top to the bottom as illustrated in FIG. 9(c), and it is possible to determine the position Q of the generation place of the Cherenkov light C.

Further, materials constituting the radiator 12 include lead glass (SiO₂+PbO), lead fluoride (PbF₂), and PWO (PbWO₄), but are not limited thereto. Materials other than the above materials may be used as the radiator 12 in consideration of the refractive index, the density, and the like according to energy of the radiation (including the γ rays) that is a detection target.

Further, an example in which the radiation position detector is used for a PET device has been described, the present invention is not limited thereto. Since the radiation position detector described above hardly causes time fluctuation with respect to light emission, radiation position detector may be used for a TOF-PET device.

Further, the example in which the light absorption layer 12d is formed on the front surface 12a and the side surface 12c of the radiator 12 is shown, but the present invention is not limited thereto. For example, when the radiator 12 is sufficiently flat and wide relative to the spread of Cherenkov light C to be emitted, the reflection of light by the side surface 12c may not be considered. In this case, the light absorption layer 12d on the side surface 12c may be removed, and the light absorption layer 12d may be formed only on the front surface 12a.

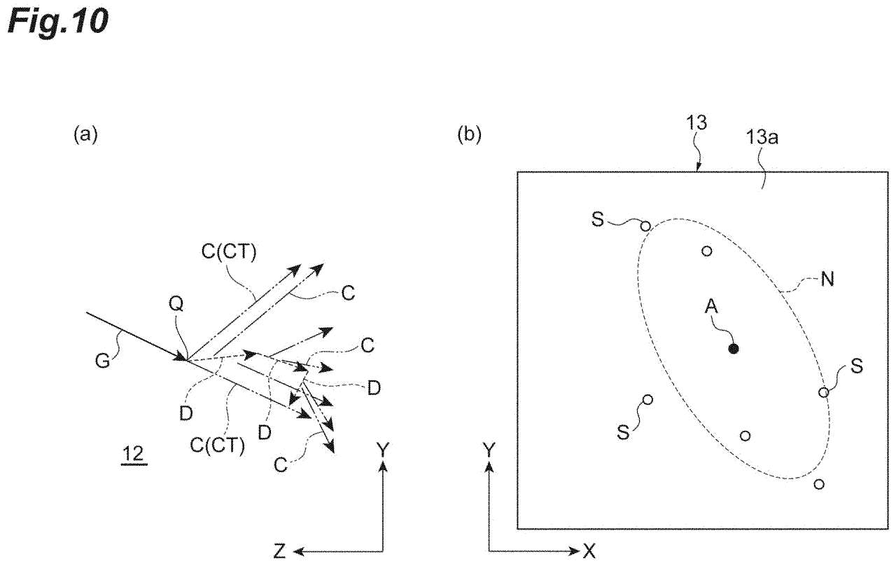

Further, as described below, the control unit 15 can obtain the position Q of the generation place of the Cherenkov light C (that is, the generation place of the photoelectron D and the interaction position of the γ ray G) (hereinafter referred to as “a first coordinate determination process”). FIG. 10 is a schematic diagram illustrating another aspect of the Cherenkov light emitted in the radiator 12. FIG. 10(a) schematically illustrates the radiator 12 in a cross-sectional view, and FIG. 10(b) schematically illustrates the photodetector 13 in a plan view.

First, as illustrated in FIG. 10(b), the control unit 15 obtains the position of the centroid A with respect to the position S of the plurality of pixels 13b which have detected the Cherenkov light C. As an example, the position of the centroid A in the X-axis direction and the Y-axis direction parallel to the back surface 12b of the radiator 12 (that is, X coordinate X_{cm} and Y coordinate Y_{cm} of the centroid A) can be obtained by Equation (12) below. Here, N is the number of the plurality of pixels 13b which have detected the Cherenkov light C, Eᵢ is detection energy of the ith photon, and Xᵢ and Yᵢ are an X coordinate and a Y coordinate of the pixel 13b at which the ith photon has been detected.

$$\begin{matrix}[ Math . 12 ] & \\ {X}_{cm} = \frac{1}{N} {\sum }_{i = 0}^{N} {E}_{i} {x}_{i} & ( 12 ) \\ {Y}_{cm} = \frac{1}{N} {\sum }_{i = 0}^{N} {E}_{i} {y}_{i} & \end{matrix}$$

Subsequently, the control unit 15 obtains an ellipse N centered on the centroid A, which is an ellipse N to be fitted to the positions S of the plurality of pixels 13b which have detected the Cherenkov light C. The control unit 15 obtains the position of the apex of the conical shape, which is the propagation locus of the Cherenkov light C, on the basis of ellipse information on the ellipse N, as in the first embodiment and the second embodiment. Here, the control unit 15 obtains the position of the apex of the conical shape in the Z axis direction perpendicular to the back surface 12b of the radiator 12 (that is, a Z coordinate of the apex of the conical shape).

Subsequently, the control unit 15 sets the X coordinate X_{cm} and the Y coordinate Y_{cm} of the centroid A as the position Q of the generation place of the Cherenkov light C in the X-axis direction and the Y-axis direction (that is, the X coordinate and the Y coordinate of the generation place of the Cherenkov light C), and sets the Z coordinate of the apex of the conical shape as the position Q of the generation place of the Cherenkov light C in the Z axis direction (that is, the Z coordinate of the generation place of the Cherenkov light C).

Even through the first coordinate determination process described above, it is possible to accurately specify the position and the time at which the γ ray G interacts with the medium in the radiator 12. Such specifying of the position Q of the generation place is particularly effective when the photoelectrons D emitted due to the interaction of the γ ray G with the medium do not go straight, as illustrated in FIG. 10(a).

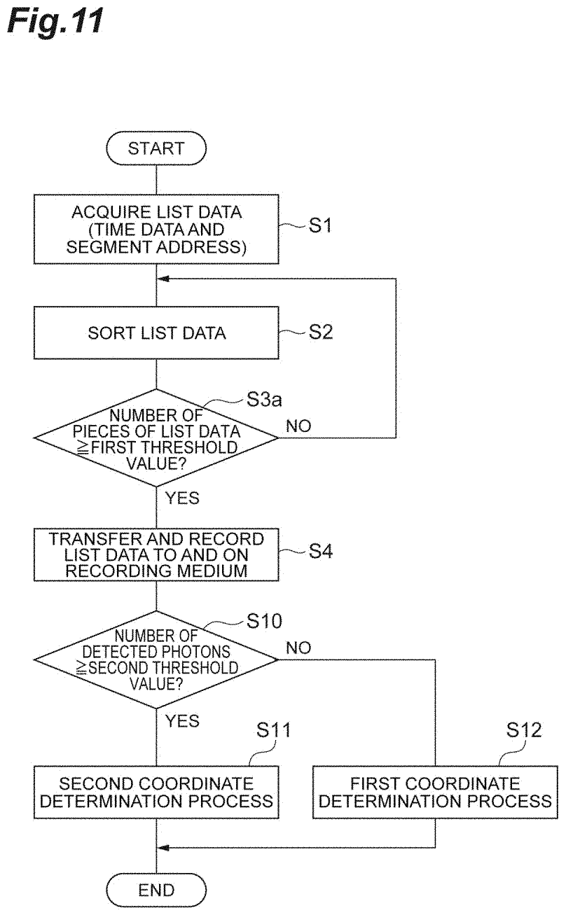

Further, the control unit 15 can perform the first coordinate determination process described above or the second coordinate determination process corresponding to steps S5 and S6 in FIGS. 6 and 8 according to the number of detected photons, as will be described below. FIG. 11 is a flowchart showing another aspect of the process flow for specifying the interaction position in the control unit of the first embodiment. It should be noted that although the case of the first embodiment will be described below, the same applies to the case of the second embodiment.

First, the signal processing circuit 16 acquires list data output from each pixel 13b of the photodetector 13 (step S1). The list data includes time information indicating a time when the pixel 13b detects the Cherenkov light and a segment address indicating a position of the pixel 13b. Subsequently, the signal processing circuit 16 sorts the plurality of acquired list data on the basis of the time information (step S2). The signal processing circuit 16 acquires the list data group which falls within the time window from the sorted list data, and determines the number of pieces of list data constituting the acquired list data group (step S3a). In step S3a, when the number of pieces of list data constituting the list data group is equal to or greater than a first threshold value, these list data are transferred to and stored in the storage medium 17 (step S4). Further, when the number of pieces of list data constituting the list data group is smaller than the first threshold value, these list data are processed as invalid data.

Subsequently, the position calculation circuit 18 determines whether or not the number of detected photons (that is, the number of the plurality of pixels 13b that have detected the Cherenkov light C) is equal to or greater than a second threshold value (step S10). In step S10, when the number of detected photons is equal to or greater than the second threshold value, the position calculation circuit 18 performs a second coordinate determination process corresponding to steps S5 and S6 in FIGS. 6 and 8 (step S11). In step S10, when the number of detected photons is smaller than the second threshold value, the position calculation circuit 18 performs the first coordinate determination process described above (step S12). It should be noted that the first threshold value and the second threshold value can be set independently of each other.

### REFERENCE SIGNS LIST

1: PET device, 10: Radiation position detector, 12: Radiator (medium), 12b: Back surface (predetermined surface), 12d: Light absorption layer, 13: Photodetector, 13b: Pixel, 15: Control unit, C: Cherenkov light, CT: Propagation locus, D: Photoelectron.

1. A radiation position detector comprising:
a radiator including a medium that generates Cherenkov light by interacting with incident radiation;
a photodetector including a plurality of two-dimensionally arrayed pixels, the plurality of pixels being disposed to correspond to a predetermined surface of the radiator; and
a control unit that acquires position information and time information of the plurality of pixels which have detected the Cherenkov light on the basis of a signal output from the photodetector, and obtains a position of a generation place of the Cherenkov light in the radiator on the basis of the acquired position information and the acquired time information, and a propagation locus of the Cherenkov light in the radiator.

2. The radiation position detector according to claim 1, wherein the control unit obtains the position of the generation place using the propagation locus of the Cherenkov light when photoelectrons are emitted from a K shell of an atom which most easily causes a photoelectric effect among atoms constituting the medium.

3. The radiation position detector according to claim 1,
wherein the propagation locus of the Cherenkov light has a conical shape centered on a locus of photoelectrons emitted by the radiation interacting with the medium, and
the position of the generation place is a position of an apex of the conical shape.

4. The radiation position detector according to claim 3, wherein the control unit obtains the position of the apex of the conical shape on the basis of ellipse information on an ellipse to be fitted to the plurality of pixels which have detected the Cherenkov light.

5. The radiation position detector according to claim 1,
wherein the propagation locus of the Cherenkov light has a conical shape centered on a locus of photoelectrons emitted by the radiation interacting with the medium, and
the control unit
obtains a position of a centroid of the plurality of pixels which have detected the Cherenkov light, and obtains a position of an apex of the conical shape on the basis of ellipse information on an ellipse centered on the centroid, the ellipse being fitted to the plurality of pixels which have detected the Cherenkov light, and
sets a position of the centroid in a direction parallel to the predetermined surface as a position of the generation place in the direction parallel to the predetermined surface and sets a position of the apex in a direction perpendicular to the predetermined surface as the position of the generation place in the direction perpendicular to the predetermined surface.

6. The radiation position detector according to claim 1, wherein the control unit obtains the position of the generation place when the number of the plurality of pixels which have detected the Cherenkov light in a predetermined period of time is larger than a predetermined number on the basis of the time information and does not obtain the position of the generation place when the number of the plurality of pixels which have detected the Cherenkov light in the predetermined period of time is smaller than the predetermined number on the basis of the time information.

7. The radiation position detector according to claim 1, further comprising:
a light absorption layer provided on an outer surface of the radiator other than the predetermined surface and configured to absorb the Cherenkov light.

8. A PET device comprising the radiation position detector according to claim 1.
